(19) United States
(12) Patent Application Publication
(10) Pub. No.: US 2019/0380910 A1
(43) Pub. Date: Dec. 19, 2019

(54) DEVICE FOR PACKAGING TWO PRODUCTS TO BE MIXED AND FOR DISPENSING THE MIXTURE OF THESE PRODUCTS

(71) Applicant: Marc Willem Franken, Fort Lauderdale (FR)

(72) Inventors: Vincent GREK, Paris (FR); Julien LEVA, Paris (FR); Estelle HABERT-ORTOLI, Paris (FR)

(21) Appl. No.: 15/840,821

(22) Filed: Dec. 13, 2017

Related U.S. Application Data
(63) Continuation of application No. 12/952,384, filed on Nov. 23, 2010, now abandoned.

(30) Foreign Application Priority Data
Nov. 30, 2009 (EP) 09306161.2

(51) Int. Cl. A61J 1/20

(52) U.S. Cl. CPC A61J 1/2096

(57) ABSTRACT

Device including a bottle having two open ends and a central body receiving a first product, one end of the bottle has an orifice receiving a stopper which contains a second product to be mixed with the first, another end of the bottle has an orifice receiving a removable cap provided for withdrawing the mixture after removal of the cap.

### CROSS REFERENCE TO RELATED APPLICATIONS

This is a continuation of U.S. patent application Ser. No. 12/952,384, filed on Nov. 23, 2010, which claims priority to European Patent Application No. 09306161.2, filed on Nov. 30, 2009, the disclosures of which are incorporated herein by reference in their entirety.

### TECHNICAL FIELD

The present invention generally concerns a device for packaging two products to be mixed, at least one thereof being a liquid product, and for dispensing the mixture of these products. One particular, but non-limiting exemplary application of the subject of this invention is a combined device intended for the extemporaneous preparing of medicinal products in the liquid state, and for the secure withdrawing of the prepared liquid preparation from the device. The problem underlying the invention is set forth below with reference to this particular application.

### BACKGROUND

The oral dosing of medicinal products in tablet form, in the solid state, is often difficult for children and the elderly notably for reasons of palatability, the size of the tablets often being too large. In addition the doses to be prescribed are not uniform and current tablets do not allow personalized dose adaptation.

Therefore, liquid forms of medicinal products can improve the palatability and personalization of doses in relation to patient age and weight in particular. However, from an industrial viewpoint, liquid forms are fairly complicated to prepare, chiefly having regard to the stability of the active ingredient in the liquid.

These difficulties warrant the interest in so-called extemporaneous liquid preparations. These consist of a mixture of two components e.g. the mixture of a powder with a liquid or the mixture of a liquid with another liquid, to prepare a reconstituted liquid product which may be a suspension or a solution, said medicinal product possibly being taken within a period of greater or shorter length after its reconstitution. The present invention lies in the field of the extemporaneous preparation of said liquid medicinal products.

Various propositions have already been put forward to form these extemporaneous preparations. As examples, mention may be made of French patents Nos 1233412, 1486502, 1508658, 2190094, 2238644, 2427960 and 2628075.

In these patents, the mixture is prepared through voluntary action on the part of the user, and the disadvantages of conventional extemporaneous preparations are not eliminated: risk of contamination for sterile products, risk of loss of part of the components, risk of using only a single component and, in general, difficulty in applying or using the method to be followed to obtain proper mixing.

Packaging and dispensing assemblies have also been proposed which allow the extemporaneous mixing of components using a screw-on and screw-off movement. In general the principle of these devices is based on the presence of a film closing a first bottle, a film that is pushed back when this bottle is screwed onto the opening of another bottle, thereby setting up communication between the two bottles and allowing the mixing of their respective contents. Depending on cases, the film is free-standing or joined to the first bottle via a hinge. As examples of said assemblies mention may be made of French patents Nos 2478607 and 2506726.

This latter form of embodiment remains fairly difficult to manipulate and comprises risks of product leakage when placing one bottle over the other and at the time of dispensing the prepared mixture. In addition, the applications thereof are limited to the mixing together of liquid products.

### BRIEF SUMMARY

The present invention sets out to remedy all the shortcomings set forth above. The invention therefore is intended to provide a device for the extemporaneous preparing of medicinal products or food supplements or similar, in the form of a packaging assembly which best meets the following requirements:
Simplifying the handling needed to carry out suitable mixing of the components, without skin, oral or respiratory contact;
When applicable, secure dosing of the prepared mixture eliminating risks related to leakage and dosage precision;
Compatibility with all extemporaneous preparations: mixing a liquid with another liquid, of aqueous or oil or gel type, or of a liquid with a solid which itself may be in any form (powder, granules, tablets, nanoparticles . . . );

whilst remaining of simple, economic design, allowing easy industrial manufacture and integration thereof in a logistics line.

For this purpose, the subject-matter of the invention is a device for the packaging of two products to be mixed, at least one thereof being a liquid product, and for dispensing the mixture of these products, the device essentially being characterized by the fact that it comprises a bottle having two open ends, the bottle comprising a central body receiving a first product, one end with an orifice, or opening, receiving a stopper which contains a second product to be mixed with the first, and another end opposite the first receiving a removable cap designed for withdrawal of the mixture after removal of the cap.

The device of the invention is therefore in the form of a small bottle with two orifices of which one receives a stopper designed to contain the liquid or solid product to be mixed with the liquid product contained in the body of the bottle, or conversely, whilst the other orifice is provided for the dispensing of the mixture obtained inside the bottle. The device is therefore a single bottle and can be used as follows: the stopper located at one end of the bottle is first actuated so as to release the product contained therein and thereby allow the mixing of this product with the other product contained in the body of the bottle; the bottle is then upturned and the cap located at its other end is removed to withdraw a suitable quantity of medicinal or other reconstituted product.

In one preferred embodiment of the device of the invention, the stopper provided at the first end of the bottle is provided with a central cavity engaged in the opening of this end and initially containing the second product, said stopper carrying a part that can be moved axially and which, when pressed down, is capable of opening the closed bottom of the cavity to release the second product. Advantageously, the stopper is equipped with a tamperproof tab whose presence holds said part away from the bottom of the cavity and whose removal allows this part to be pushed down with a view to opening the closed bottom of the cavity to release the second product. This stopper can be a screw-on stopper or a stopper press-fitted onto the bottle.

Regarding the other end of the bottle which receives the cap, this end may also carry or itself form a section reducer with a central orifice having a diameter corresponding to the diameter of a dosing syringe which can be used to withdraw the mixture in secure, sterile manner with no risk of leakage.

### BRIEF DESCRIPTION OF THE DRAWINGS

In all cases, the invention will be better understood in the light of the following description with reference to the appended schematic drawings which illustrate an exemplary embodiment of the device for packaging two products to be mixed and for dispensing the mixture of these products.

FIG. 1 is an outer, overall view of a device conforming to the present invention showing a dosing syringe which can be used with this device.

FIG. 2 is a longitudinal section view of the device in FIG. 1.

FIG. 3 is a cross-sectional view, on magnified scale, of the end of this device comprising the stopper.

FIGS. 4 to 8 are schematic illustrations of the device in the preceding figures.

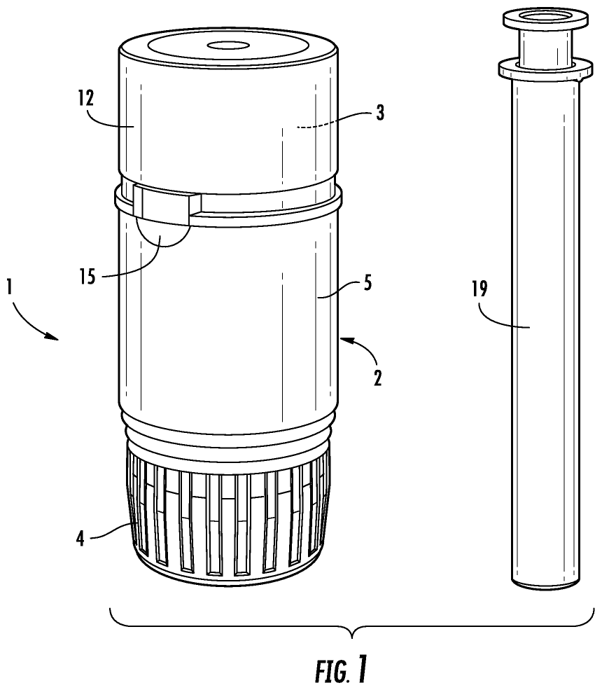

### DETAILED DESCRIPTION

The device shown in the drawing and globally denoted 1 chiefly comprises a bottle 2 open at its two ends, a stopper 3 placed at one end of the bottle 2, and a cap 4 mounted on the other end of this bottle 2.

The bottle 2 has a central body 5, preferably made in a transparent material. At one end, the bottle 2 has a first circular opening 6. This end can be provided with a thread 7 (if the stopper 3 is a screw-on stopper). At its other end, also open, the bottle 2 can be provided with an outer thread 8 (if the cap is a screw-on cap).

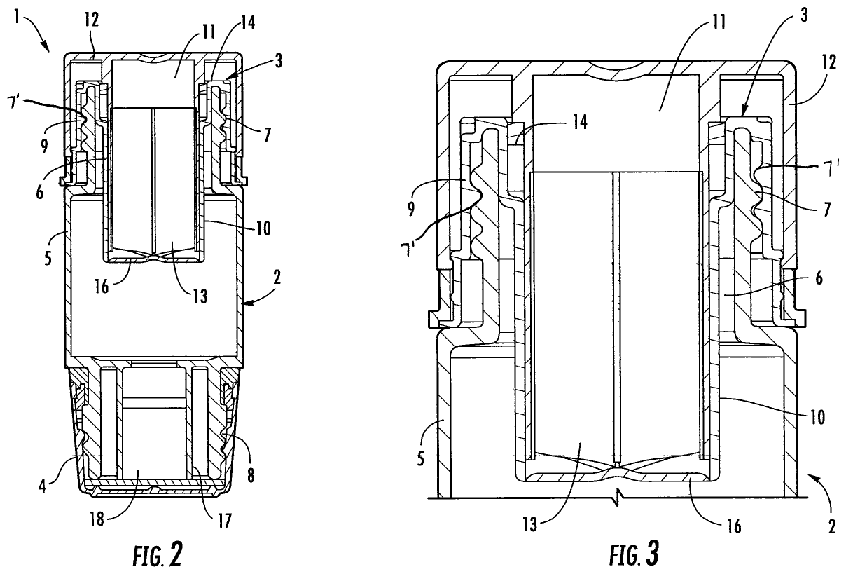

With more particular reference to FIGS. 2 and 3, the stopper 3 has an outer skirt 9 provided with an inner thread 7′ cooperating with the outer thread 7 of the bottle 2. The stopper 3 also has a central part 10 in the form of a jar which is engaged in the circular opening 6 of the bottle and which delimits a cavity 11.

A part 12 of general cylindrical appearance caps the stopper 3 and also engages, via its projecting central part 13, into the cavity 11 delimited by the central part 10 of said stopper 3. A ring-shaped seal 14 is inserted between the top of the stopper 3 and the central part 13 of part 12.

A tamperproof tab 15 is provided at the base of part 12, around the lower region of the outer skirt 9 of the stopper 3. The initial presence of the tamperproof tab 15 holds the central part 13 of part 12 distant from the bottom 16 of the cavity 11.

This cavity 11 is provided to receive one of the two products (liquid or solid) to be mixed, whilst the central body 5 of the bottle 2 is provided to receive the other product (liquid or solid). As will be understood, the two products remain well separated from one another for as long as the closed bottom 16 of the cavity 11 remains in place.

At its other end, in the illustrated example, the bottle 2 receives a section reducer 17, added and welded, that delimits a central orifice 18 of circular shape. The diameter of the central orifice 18 corresponds to the diameter of a dosing syringe 19, known per se. The cap 4 initially caps the reducer 17 on which it is mounted (thread 8).

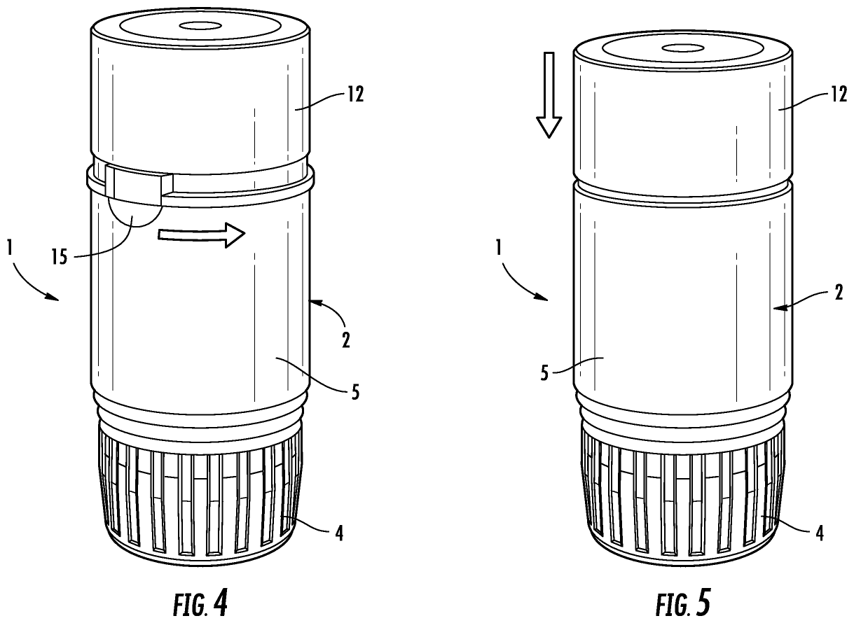

At the time of use, the tamperproof tab 15 is torn off (FIG. 4) and part 12 which is released axially over a certain distance is pressed down (FIG. 5) so as to open the closed bottom 16 of the cavity 11. The product initially contained in this cavity 11 then falls into the central body 5 of the bottle 2 where it mixes with the product already contained in said central body 5. The mixture of the two products is made homogeneous by shaking the device.

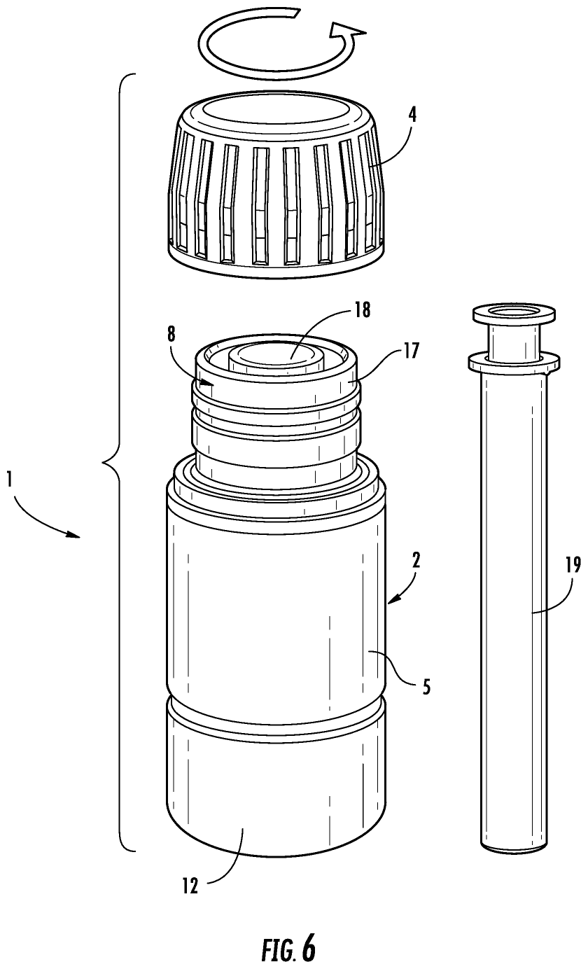

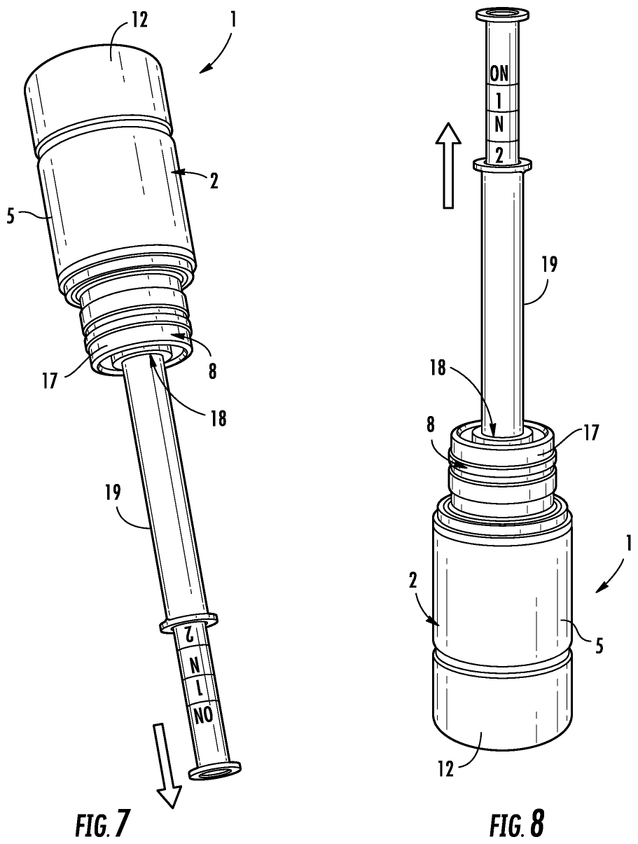

The device is then upturned and the cap 4 is removed, as shown FIG. 6. The dosing syringe 19 is next inserted in the orifice 18 and used to withdraw a determined quantity of the formed extemporaneous preparation (FIG. 7). After dosing, the syringe 19 is withdrawn (FIG. 8) and used to administer the medicinal product. Finally, the cap 4 is put back in place, at least if the device is not empty.

The device described above is particularly well suited for extemporaneous preparations of liquid medicinal products made from two liquid products or from a solid and a liquid, the term <<liquid>> designating aqueous products as well as oil products or gels. These may be preparations for oral or intravenous use. This device can also be used to prepare food supplements, or for any other similar preparations which require the separate storage of two products of which at least one is liquid, followed by the mixing of these products and dispensing of the formed mixture with or without precise dosing. Therefore the use comprising a dosing syringe and a section reducer adapted for said syringe is in no way compulsory, and it can just as well be envisaged that the second end of the bottle does not contain a section reducer and receives a teat or is directly brought to the mouth for drinking or swallowing the content, any form of withdrawal of this content possibly being envisaged.

The invention, as follows from the foregoing, is evidently not limited to the sole embodiment of this device for packaging two products to be mixed and for dispensing the mixture of these products, as described above by way of example; on the contrary it encompasses all variants of embodiment and application which follow the same principle. Therefore, it would notably lie within the scope of the invention if modifications were made to details of shapes and to the assemblies of the components of the device, for example by modifying the volume of the bottle, by replacing the screw-on cap by a press-fit cap or by arrangements such as adding or eliminating seals between these components or through the use of accessories or additional accessories intended to facilitate the use of the device; it can therefore be envisaged for example to adapt onto the stopper or the bottle itself an <<intelligent label>> which forms a type of visual alarm allowing measurement of the time elapsed since the contacting of the two liquids or of the liquid with the solid.

1. A device comprising: a bottle having two open ends, the bottle comprising a central body receiving a first product, one end with an opening receiving a stopper, said stopper having a central part in the form of a jar which is engaged in said opening and which delimits a cavity which initially contains a second product to be mixed with the first product and another end opposite the one end with an opening receiving a removable cap and provided for withdrawing the mixture after removal of the cap, said stopper carrying a part which can be moved axially and capable, when pressed down, of opening a closed bottom of the cavity to release the second product, said part engaging, via a projecting central part, into the cavity, the bottle further including an outer thread adjacent the end receiving the stopper and the stopper further including an outer skirt with an inner thread, wherein the inner thread cooperates with the outer thread.

2. The device according to claim 1, wherein the stopper is equipped with a tamperproof tab whose presence holds said projecting central part of the part distant from the closed bottom of the cavity, and whose removal allows the part to be pressed down with a view to opening the closed bottom of the cavity to release the second product.

3. The device according to claim 1, wherein the other end of the bottle, receiving the cap also carries, or itself forms, a section reducer with a central orifice having a diameter corresponding to the diameter of a dosing syringe which can be used to withdraw the mixture.

4. The device according to claim 1, further configured for an extemporaneous preparation of liquid medicinal products, or for preparation of food supplements.
